(19) United States
(12) Patent Application Publication
(10) Pub. No.: US 2012/0298315 A1
(43) Pub. Date: Nov. 29, 2012

(54) AWNING MOTION SENSOR

(76) Inventors: OSCAR SOLIS MARQUEZ, SAN CLEMENTE, CA (US); FRANCO CONSADORI, SAN CLEMENTE, CA (US)

(21) Appl. No.: 13/118,005

(22) Filed: May 27, 2011

(51) Int. Cl. E05F 15/20

(52) U.S. Cl. 160/1

(57) ABSTRACT

An awning control system for providing automatic retraction of one or more awnings by detection of motion of an awning lead rail generally includes a sensing circuit for providing a radio frequency signal, is receivable by one or more awning motors for retracting corresponding awnings into corresponding awning cassettes upon receipt of a deflection signal. The deflection signal is provided by a motion detector connected to an awning header.

Many retractable awning systems, as installed on motorhomes and buildings, have systems for automatically retracting the awning under severe wind conditions which may otherwise damage the awning fabric or framework. A control device is often used with sensors for either measuring wind speed or the motion of the awning. Useful sensors are those that sense or detect wind speed or awning motion such as anemometers, strain gauges and accelerometers, to name a few.

### SUMMARY OF THE INVENTION

An awning control system in accordance with the present invention provides automatic retraction of an extended awning upon detection of motion of an awning lead rail, or header.

In general, the present invention includes a lead rail housing fixable to the awning lead rail along with a sensing circuit for providing a radio frequency signal (wind signal), corresponding to awning deflection or wind speed. The signal is receivable by an awning motor which in turn is effective in retracting the awning with the lead rail into an awning cassette.

The deflection signal is provided by a motion detector connected to the sensor circuit and occurs upon a preset movement of the motion detector.

A magnetic power switch is incorporated in the sensing circuit for disabling the wind signal when the magnet power switch is in a magnetic field. In this manner, the magnetic power switch turns off the system when the awning is retracted.

A magnet, disposed in the awning cassette provides an operative magnetic field to the magnet power switch when the awning lead rail resides in the awning cassette.

It should be appreciated that the control system in accordance with the present invention may be also used as an improvement to an existing awning control system having already installed a motor for retraction of the awning.

More particularly, the system in accordance with the present invention includes a motion detector having a limit switch having an activator lever disposed in the lead rail housing for closing the limit switch upon a preselected vertical movement of the lever, which is due to inertial movement of a weight disposed on the lever. Positional adjustment of the weight along the lever provides for a sensitivity adjustment as to preset movement of the header.

It should be appreciated that the sensing circuit, although shown installed in a single header housing may be utilized for controlling a plurality of awnings, each having an awning motor receptive to the wind signal transmitted by the sensing circuit.

### BRIEF DESCRIPTION OF THE DRAWINGS

The advantages and features of the present invention will be better understood by the following description when considered in conjunction with the accompanying drawings, in which:

FIG. 1 is a perspective view of an extended awning generally showing a lead rail disposed in a spaced apart relationship with an awning cassette and interconnected with the lead rail by arms, a motion sensor is shown attached to the lead rail for sensing deflection or movement thereof;

FIG. 2 is a perspective view similar to that shown in FIG. 1 at an angle showing a magnetic bracket attached to an awning cassette; and

FIG. 3 is a schematic drawing of a lead rail housing along with a sensing circuit for providing a radio frequency signal, or “wind signal” corresponding to wind speed, a motion detector connected to the sensor circuit along with a magnet power switch incorporated into the sensing circuit. A magnet disposed exterior to the lead rail housing provides an operative magnetic field to the magnet power switch when the awning lead rail resides in the awning cassette following withdrawal of the awning, not shown.

### DETAILED DESCRIPTION

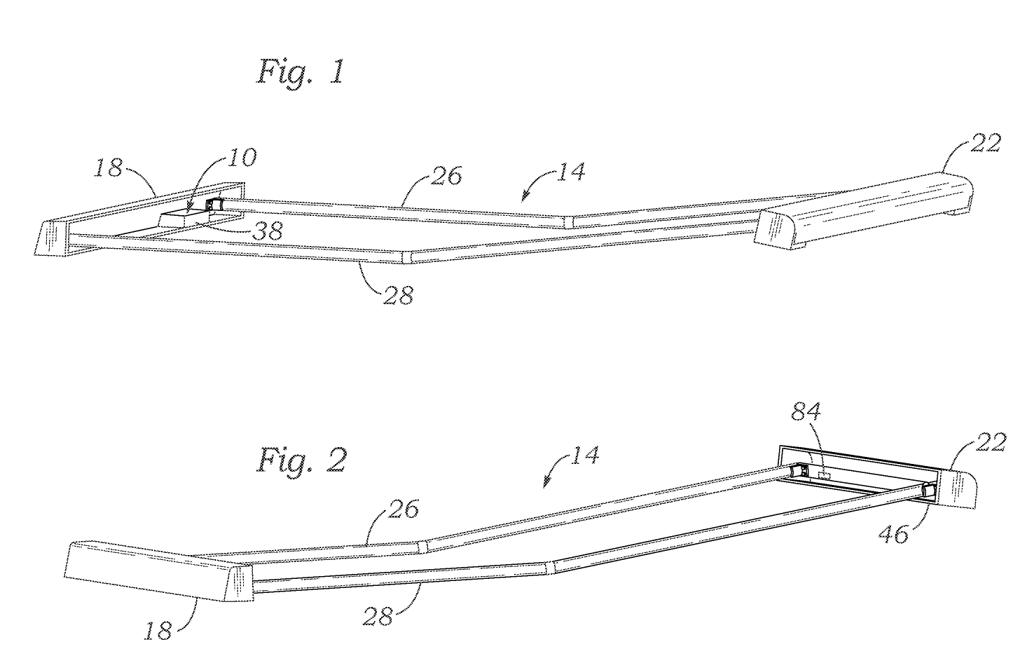

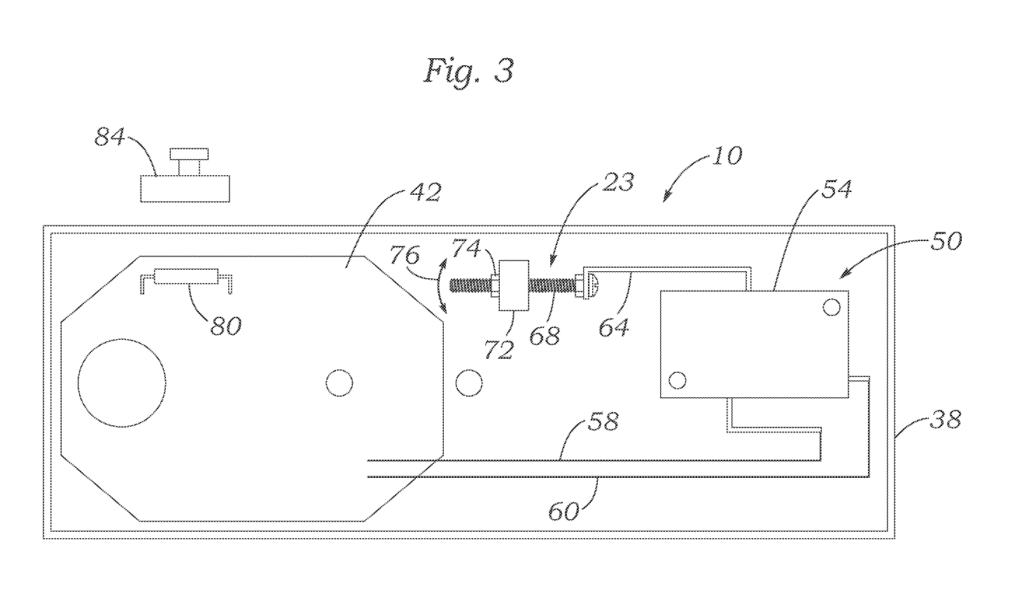

With reference to FIGS. 1-3, particularly FIG. 3, there is shown an awning control system 10, which provides for automatic retraction of one or more extendable awnings 14, only one being shown for clarity purposes. The system 10 is installed on a lead rail 18 of the awning 14, with the lead rail 18 interconnected to an awning cassette 22 by arms 26, 28 in a conventional manner when retracted. When retracted, the lead rail 18 resides within the cassette 22, this position not being shown in the figures. The awning, including lead rail 18, cassette 22, and arms 26, 28 are conventional in construction and operation, accordingly no further detail is presented.

With reference again to FIG. 3, the system 10 includes a housing 38 attached to the lead rail 18 (FIG. 1) in a conventional manner for encasing a sensing circuit 42 which provides for a radio frequency wind signal, which is receivable by an awning motor 46 through a conventional receiver, not shown. Any suitable radio frequency circuitry in the sensing circuit 42 and receivable by the motor 46, enables retraction of the awning into the cassette.

The deflection signal is provided by a motion detector 50 disposed within the housing 38, see FIG. 3.

The motion detector 50 utilizes a conventional limit switch 54 to close a normally open circuit between interconnecting wires 58, 60. Closing of the circuit initiates the RF wind signal by way of the sensing circuit 42, any conventional electronic circuitry being utilized for this purpose.

Operation of the limit switch 54 is through a lever 64 including a threaded portion 68 having a weight 72 screwed thereon and fixed by a nut 74. By adjusting the lateral position of the weight 72 along the lever 64 by rotation of the weight 72 on the threaded portion 68 presets the amount of inertial movement of the weight necessary to close the interconnecting wires 58, 60. Thus, the system 10 provides for a simple low cost mechanism with ease of calibration, i.e. sensitivity adjustment, along with a rugged construction to provide for dependable outdoor operation.

The motion detector 50 in accordance with the present invention utilizes a commercially available limit switch 54, as hereinabove noted, for closing the circuitry 58, 60 when the lever 64 is caused to deflect downwards due to the inertia movement of the weight 72 when a vertical motion is applied, see arrow 76, due to wind gusts or the like.

It should be appreciated that a single sensing circuit installed in one of the awning lead rails 18 is able to control nearby awnings, not shown, each having a suitable signal receiving motor.

With reference again to FIGS. 2 and 3, in order to maintain the lead rail 18 within the cassette 22 and non-responsive to operation of the motion detector 50 and sensing circuit 42, a conventional magnetic power switch 80 is incorporated into the sensing circuit 42. Magnetic coupling of the conventional magnetic power switch 80 and a magnet 84 disables the sensing circuit 42. Thus, when the lead rail 18 resides in the cassette 22, control of the motor 46 by the sensing circuit 42 is disabled. Deployment of the awning and extension of the lead rail 18 from the cassette 22 is effected through a separate signal to the motor 46 in a conventional manner.

Although there has been hereinabove described a specific awning control system in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. An awning control system for providing automatic retraction of an extended awning upon detection of unwanted motion of an awning lead rail, the system comprising:
a header housing fixable to the awning lead rail;
a sensing circuit, disposed in the housing, for providing a radio frequency signal corresponding to lead rail displacement;
an awning motor, responsive to the radio frequency signal, for retracting said awning into an awning cassette;
a motion detector connected to said sensor circuit for activating said sensing circuit upon a preset movement of the motion detector;
a magnet power switch incorporated into said sensing circuit for disabling the sensing circuit when said magnet power switch is in a magnetic field; and
a magnet, disposed in said awning cassette, for providing an operative magnetic field to said magnet power switch when said awning lead rail resides in said awning cassette.

2. In an awning control system for providing automatic retraction of an extended awning upon detection of unwanted motion of an awning header, an improvement comprising:
a header housing fixable to the awning lead rail;
a sensing circuit, disposed in the housing, for providing a radio frequency signal corresponding to lead rail displacement;
an awning motor respond to the radio frequency signal for retracting said awning into an awning cassette;
a motion detector connected to said sensor circuit for activating the sensor circuit upon a preset movement of the motion detection;
a magnet power switch incorporated into said sensing circuit for disabling the sensor circuit when said magnet power switch is in a magnetic field; and
a magnet, disposed in said awning cassette box, for providing an operative magnetic field to said magnet power switch when said awning lead rail resides in said awning cassette.

3. The system according to claim 1 wherein said motion detection comprises a limit switch having an activation lever disposed in said lead rail housing for closing said limit switch upon vertical motion of the lever due to inertial movement of a weight disposed on the lever.

4. The system according to claim 3 wherein said weight is slidably disposed on said lever in order to control the preset movement.

5. The improvement according to claim 2 wherein said motion detection comprises a limit switch having an activation lever disposed in said header housing for closing said limit switch upon vertical motion of the lever due to inertial movement of a weight disposed on the lever.

6. The improvement according to claim 5 wherein said weight is slidably disposed on said lever in order to control the preset movement.

7. An awning control system for providing automatic retraction of a plurality of extendable awnings upon detection of motion of an awning lead rail, the system comprising:
a header housing fixable to at least one of the awning lead rails;
a sensing circuit for providing a wind signal receivable by a plurality of awning motors for retracting a corresponding awning into a corresponding awning cassette upon receipt of a lead rail deflection signal; and
a motion detection connected to said sensor circuit for providing the deflection signal upon preset deflection of the motion detection.

8. The system according to claim 7 further comprising:
a magnet power switch incorporated into said sensing circuit for disabling the wind signal when said magnet power switch is in a magnetic field; and
a magnet, disposed in said awning cassette box, for providing an operative magnetic field to said magnet power switch when said awning lead rail resides in said awning cassette.

9. The system according to claim 8 wherein said motion detection comprises a limit switch having an activation lever disposed in said lead rail for closing said limit switch upon vertical motion of the lever due to inertial movement of a weight disposed on said lever.

10. The system according to claim 9 wherein said weight is slidably disposed on said lever in order to control the preset movement.
